(19) United States
(12) Patent Application Publication
(10) Pub. No.: US 2016/0304369 A1
(43) Pub. Date: Oct. 20, 2016

(54) METHOD FOR BIOLOGICAL PURIFICATION OF WATER

(71) Applicant: BIOWATER TECHNOLOGY AS, Tønsberg (NO)

(72) Inventors: Gang XIN, Sandvika (NO); Bjørn RUSTEN, Strum, WI (US)

(73) Assignee: BioWater Technology AS, Tønsberg (NO)

(21) Appl. No.: 15/102,166

(22) PCT Filed: Dec. 9, 2014
(86) PCT No.: PCT/NO2014/050227

§ 371 Date: Jun. 6, 2016

(30) Foreign Application Priority Data
Dec. 9, 2013 (NO) 20131634

(51) Int. Cl. C02F 3/08; C02F 3/30; C02F 3/12

(52) U.S. Cl. CPC C02F 3/085; C02F 3/1273; C02F 3/303; C02F 3/308; C02F 2103/007

(57) ABSTRACT

It is described a method for biological purification of water, the method comprising: leading the water into a reactor through one or more inlet pipes or inlet zones; leading the water and substrate through carrier elements for biofilm growth which have a high protected surface area (>200 m²/m³ carrier elements) and a large pore volume (>60%); wherein one or more membrane units are submerged in the water in the reactor; wherein permeate is pulled out of the reactor through the pores of the membranes; wherein oxygen-containing gas is supplied in the reactor through an aeration system; wherein during normal operation the water level in the reactor is maintained below one or more outlet pipes or outlet zones that are dedicated for excess sludge removal; wherein during washing operation strong turbulence is created for removal of excess sludge as the water level in the reactor is temporarily raised to the level where the outlet pipes or outlet zones that are dedicated for excess sludge removal are.

The present invention relates to a method for biological purification of municipal wastewater, industrial wastewater, surface water and ground water in a bioreactor where water and substrate come into contact with carrier elements for biofilm growth and effluent water (permeate) comes out by membrane filtration in a submerged membrane unit that is placed in the bioreactor where the carrier elements are retained.

The process can be arranged for aerobic purification of municipal wastewater, industrial wastewater, surface water and ground water. The process is based on the principle that biomass is established on a carrier element for the formation of biofilm growth. The carrier elements are held in place in the reactor with the help of a sieve. The carrier elements are in contact with the membrane surface in the bioreactor. Permeate that has low turbidity is pulled out of the bioreactor with a submerged membrane filtration system that contains membranes that are made of either inorganic materials (ceramic or metallic) or polymeric materials, which allows the permeate to be reused. Oxygen-containing gas bubbles are provided by aeration devices that are placed at the bottom of the bioreactor, preferably right underneath the membrane elements. The gas bubbles serve several purposes including providing oxygen as an electron acceptor for micro-organism growth, mobilizing carrier elements and other suspended particles in the bioreactor and scouring off deposits on the membrane surface.

### BACKGROUND

### Biological Treatment Processes

A number of methods for mechanical, chemical and biological purification of water are known. Biological purification entails that a culture of micro-organisms carries out the desired transformation of the materials in the Water. Biological purification is, to a large extent, combined with mechanical and chemical purification methods.

Biological purification is much used for purification of polluted water. Traditionally, biological purification has been completely dominating for removal of organic materials and, for the last years, biological purification has also become dominating for the removal of nitrogen (nitrification, denitrification, anammox) and relatively common for removal of phosphorous (bio-P removal).

One distinguishes between aerobic, anoxic and anaerobic biological processes. In aerobic processes the micro-organisms need molecular oxygen as an electron acceptor. For anoxic processes one depends on the absence of molecular oxygen and the micro-organisms will use nitrate as the electron acceptor. For biological removal of nitrogen one combines an aerobic process, which oxidizes ammonium to nitrate, with an anoxic process that reduces nitrate to molecular nitrogen gas. For bio-P removal the microorganisms must be alternately exposed to an anaerobic (no oxygen or nitrate) environment and an aerobic environment, in order to trigger the phosphorus release in the anaerobic bioreactor and the luxury phosphorus uptake in the aerobic bioreactor. True anaerobic processes take place in the absence of oxygen and nitrate and are characterized in that the organic material in the water is both electron donor and electron acceptor. Anaerobic processes are most relevant for highly concentrated industrial discharge of organic matter and in a complete decomposition the end product will be a mixture of methane and carbon dioxide (biogas).

The micro-organisms one needs for biological purification could, in principle, be suspended in the water phase in a bioreactor, or be attached to surfaces in the bioreactor. A process with suspended micro-organisms is called an activated sludge process. The micro-organisms in an activated sludge process must be able to form flocs that are separated from the water in a downstream reactor and are returned to the bioreactor. Alternatively, the suspended micro-organisms can be held in place in the bioreactor in that the purified water is drained from the bioreactor via membranes with pore openings so small that the micro-organisms are held back in the bioreactor. This is known as a membrane bioreactor (MBR) process.

A process where the micro-organisms are attached to a surface is called a biofilm process. Examples of biofilm processes used in purification of water are trickling filters, submerged biological filters, moving bed processes and fluidized bed processes. Submerged biological filters include both filters with a relatively open carrier medium of plastic and filters with a carrier medium of a small diameter (sand, Leca balls, small polystyrene balls). Submerged biological filters with a carrier medium of a small diameter will relatively quickly be clogged up with biosludge and must be regularly taken out of operation for back flushing and removal of the sludge. Submerged biological filters with an open carrier medium that are kept lying still can be operated for a relatively long time with a continuous supply of water, but experience has shown that even filters with a large carrier medium and an open structure will be clogged up after some time. As the micro-organisms in biofilm processes are fixed on the surface of a carrier material in a bioreactor, the biofilm process itself is independent of downstream sludge separation.

Combinations of processes with suspended micro-organisms and processes with fixed micro-organisms in the same bioreactor are known as IFAS (integrated fixed film and activated sludge) processes. IFAS processes have been comprised of activated sludge in combination with either submerged biological filters with an open carrier medium or moving bed processes.

On a global basis, there are clearly more biological purification plants with suspended micro-organisms, but biofilm processes are becoming more and more popular. Some of the reasons for this are that activated sludge processes have a number of disadvantages. It is often difficult to keep control of the sludge separation. This can lead to large losses of sludge and, in the worst case that the biological process collapses, with the associated consequences for the recipient. Another disadvantage is that conventional activated sludge processes need very large volumes both for the reactor and for the sludge separation in the sedimentation basin. However, the advantage with conventional activated sludge processes is that the water is treated in open reactors where there is no danger of the reactor becoming blocked.

Traditional trickling filters are the biofilm processes that were first taken into use for purification of wastewater. Initially, trickling filters were filled with stone, but modern trickling filters are filled with plastic materials with a larger surface area for the biofilm to grow on. Modern trickling filters are relatively tall. The water is pumped to the top of the trickling filter and distributed evenly over the whole surface. The supply of oxygen takes place by natural ventilation. It is difficult to adjust the amount of water, load of matter and natural supply of oxygen in a trickling filter so that everything functions optimally. It is relatively common that the biofilm in the upper parts of a trickling filter does not get enough oxygen. Therefore, trickling filters have normally lower conversion rates and require larger reactor volumes than other biofilm processes. To avoid becoming clogged up the biofilm medium must be relatively open and the specific biofilm area (m² biofilm per m³ reactor volume) becomes relatively small. This also contributes to an increased reactor volume. Even with an open biofilm medium, clogging and channel formation in trickling filters are well known problems which can be kept under control in that one ensures that each part of the trickling filter is repeatedly subjected to a hydraulic load which is sufficiently large to rinse particulate matter and loosened biofilm out of the trickling filter. In many cases this means that one must recirculate water over the trickling filter. With a height of many meters, energy costs for pumping can be considerable.

Submerged biological filters may use a relatively open biofilm medium, in principle the same type of plastic material as modern trickling filters. The plastic material is stationary, submerged in the reactor and oxygen is supplied via diffuser aerators at the bottom of the reactor. A problem with submerged biofilters of this type has been clogging from growth of biomass and formation of channels. Water and air take the path of least resistance and zones are formed in aerated reactors where the biomass is accumulated resulting in anaerobic conditions. Another disadvantage is that one has no access to the aerators below the stationary biofilm medium. For maintenance or replacing of the aerators one must first remove the biofilm medium from the reactor.

Submerged biological filters with a carrier medium of a small diameter (sand, Leca balls, and small polystyrene balls) have a very large biofilm surface area.

The carrier medium is stationary during normal operation, but this type of filter will clog up with biosludge and must regularly be taken out of operation for back flushing and removal of sludge. The process is sensitive to particles in the wastewater and for wastewaters with much suspended matter the operation cycles between each flushing become very short. Because of fittings for flushing and placing of the aerator at the bottom of the reactors, these types of biofilm reactors are complicated to construct. A common designation for this type of biofilm reactor is BAF (biological aerated filter) and the best known brand names are Biostyr, Biocarbone and Biofor.

In moving bed reactors, the biofilm grows on a carrier material that floats freely around in the reactor. The carrier material has either been foam rubber or small elements of plastic. Processes that use foam rubber pieces are known by the names Captor and Linpor. The disadvantages with foam rubber pieces are that the effective biofilm area is too small because the growth on the outside of the foam rubber pieces clogs up the pores and prevents ingress of substrate and oxygen to the inner parts of the foam rubber pieces. Furthermore, one must use sieves that prevent the foam rubber pieces from leaving the reactors and one must have a system which regularly pumps the foam rubber pieces away from the sieves to prevent these from blocking up. Therefore, very few plants have been built with foam rubber as the carrier material.

However, in recent years a series of purification plants have been built with moving bed processes where the carrier material is small pieces of plastic. The pieces of plastic are normally distributed evenly in the whole of the water volume and in practice one operates with degrees of filling with biofilm medium up to about 67%. Sieves keep the plastic pieces in place in the reactor. The reactors are operated continuously without the need for back flushing. It is important that there must be a steady stream of produced sludge to the subsequent separation process so that the particle load becomes much smaller than for separation of activated sludge. It is also pointed out that this is a continuous process, in contrast to biofilter processes with regular back flushing. The process is very flexible with regard to the shape of the bioreactor. The specific biofilm surface area is higher than for trickling filters, but considerably smaller than in BAF processes. However, on a total volume basis moving bed processes with a carrier material of small plastic pieces have been found to be as efficient as BAF processes when one takes into account the extra volume one needs for expansion of the filter bed and for the flushing water reservoir in the BAF processes. Examples of suppliers of moving bed processes with small plastic pieces as a carrier material are Kruger Kaldnes, Infilco, Degremont, Biowater Technology and Aqwise systems.

Recently, a new biofilm process, namely Continuous Flow Intermittent Cleaning (CFIC) process, has been developed by Biowater Technology. CFIC contains highly packed plastic carriers to a degree (typically larger than 90% filling degree) that little movement of the carriers occurs in the reactor. With such a configuration, high carbon and nutrient gradients are created inside the biofilm when wastewater passes through the reactor in a plug flow manner, resulting in a better transfer of substrate than in a moving bed biofilm reactor. In an aerated CFIC reactor, oxygen transfer efficiency will be improved since air bubbles will have to travel through the highly packed carriers, thereby creating a long retention time and pathway before the air bubbles reach the reactor surface. Highly packed carriers can also serve as a “filter” to reduce solids concentrations in the treated water and thus lower particle loads to a subsequent separation process, and even in certain cases, direct discharge of CFIC effluent without going through a separation stage becomes feasible. Excess biological sludge in the reactor is removed in periodical forward flow washing by raising the water volume (lowered carrier packing degrees) with influent wastewater and providing strong turbulence. The effluent water during washing, which contains high concentrations of particles, can be handled in a small separation unit, such as a sludge thickener or a fine micro sieve filter. The process is very flexible with regard to the shape of the bioreactor. The specific biofilm surface area is higher than for moving bed biofilm reactors, resulting in smaller reactor footprint.

### Wastewater Reuse Processes

With the increased worldwide pressure on water resources, recycle and reuse of secondary and tertiary treated wastewater for irrigation, agriculture and industrial process water, as well as for indirect and even direct potable water supply, are gaining momentum. In secondary treatment, biological treatment and chemical processes are used to removal most of the organic matters. Separation processes, such as sedimentation and dissolved air flotation, are also typically included in the secondary treatment. Effluent from secondary treatment processes contains residue suspended and colloidal particulate matter that may require further removal in a tertiary process. Most commonly used tertiary treatment processes are depth filtration, surface filtration and membrane filtration. Currently, mainly three technical combinations are used worldwide for wastewater reuse where biological treatment is required: 1) biological treatment with separation process followed by depth or surface filtration; 2) biological treatment with separation process followed by membrane filtration and 3) the membrane bioreactor (MBR) process. Before water reuse, tertiary effluent typically goes through a disinfection stage. A reverse osmosis (RO) membrane has to be used if potable water (both indirect and direct) is targeted.

Depth filtration is one of the oldest processes used in the treatment of potable water and is the most common method used for secondary effluent filtration for wastewater reuse. Sand, anthracite, and synthetic fiber are commonly used in depth filtration. Clogging is the most common problem that depth filtration processes have. Filters must be taken off-line periodically for backwashing to prevent clogging. Recently, continuously operated depth filtration processes, such as the Dynasand process, have become more popular in wastewater reuse applications than those semi-continuous processes.

Surface filtration is a type of filtration using fabric materials, such as cloth, woven metal fabrics and a variety of synthetic materials, as filtration medium. Membrane filtration is also a type of surface filtration.

With conventional depth filtration and surface filtration, turbidity breakthrough is one of the most common concerns of stakeholders in wastewater reuse applications. Although conventional filtration has typically initial low capital costs, operational costs, in terms of chemical consumption and medium replacement, can be higher than for membrane filtration. If a RO process is used in the downstream for further water purification, the conventional filtration typically cannot provide high quality feed water (low silt density index, SDI) to RO, resulting in degraded performance of RO process.

Based on sizes of membrane pores, membrane filtration can be categorized into microfiltration (MF), ultrafiltration (UF), nanofiltration (NF) and reverse osmosis (RO). In tertiary wastewater treatment, MF and UF are typically used for particle separation after a secondary biological treatment. There are essentially two basic flow patterns with membranes: outside-in and inside-out. In most wastewater applications where TSS and turbidity are typically high in feed water, outside in is more commonly used. Two process configurations are used with membrane modules: pressurized and submerged, and both configurations are common in wastewater reuse applications.

Activated sludge with secondary clarification followed by a MF or UF has been widely used worldwide for new wastewater treatment plants and more commonly for upgrading existing activated sludge plants for reuse. In the process, the membrane filtration stage (MF or UF) is separated from the activated sludge stage by a secondary effluent storage tank.

Membrane bioreactor (MBR) provides an alternative to activated sludge followed by MF or UF by combining biological treatment with the UF or MF membrane separation in one unit. Some of the MBR technology uses the same membranes and even membrane devices as those used for tertiary treatment. More commonly, membranes and module formats are specially designed for MBR requirements. Although cross-flow sidestream MBRs are not uncommon for small scale industrial wastewater treatment and reuse, submerged MBRs, either in the flat sheet format or in the hollow fiber format, are dominant in both municipal and industrial wastewater applications.

One of the main advantages of the MBR process is that it eliminates the secondary clarification unit, which significantly reduces the overall footprint of the biological treatment plant. The sludge bulking problem is not much relevant to the MBR process. Another advantage is that without losing biomass in the effluent, one can raise biomass concentration in MBR to a level that cannot be achieved in typical activated sludge plants. Thus, further footprint reduction can be achieved with MBR. The disadvantages of the process are that it is still costly and energy demanding. Two design aspects lead to high energy requirements in MBR. One is that coarse bubble air scouring is always used for reducing solids deposit on membrane surface in submerged MBRs. The other aspect is that high internal recirculation flow (typically 3-6 times of the feed water flow rate) is used for reducing the sludge concentration difference between the zone that the membranes are located in and the rest of the biological reactor.

MB-MBR (moving bed membrane bioreactor) is a hybrid system where the moving bed bioreactor is followed by a submerged membrane bioreactor. Biofilm carriers are retained in the moving bed bioreactor by sieves and have no direct contact with the membrane.

The present invention is a method for biological purification of municipal and industrial wastewater in a bioreactor where water and substrate come into contact with biofilm carrier elements and treated water comes out by membrane filtration in submerged membrane modules. Aeration is provided for both mobilizing biofilm carriers and scouring membrane surface. The carrier elements are in direct contact with the membrane surface. Periodically, the bioreactor will enter a washing operation mode for maintaining membrane permeability and for removing excess sludge that has been accumulated in the bioreactor during the normal operation.

### Relevant Prior Art

NO 172687 describes a method and a reactor for water purification. The water is fed into the reactor which is filled with the carriers for the biofilm. These carriers have a specific weight in the area 0.90-1.20 and a degree of filling for the carriers of 30-70% of the reactor volume. Furthermore, the reactor has mixing equipment and also appliances in the forms of a sieve plate to retain the carriers in the reactor.

EP 2438019 A1 describes a method and a reactor for water purification. The water is fed into the reactor which is filled with the carriers for the biofilm. These carriers have a specific weight in the area 0.8-1.4 and a degree of filling for the carriers of 90-100% of the reactor volume. The carriers are kept at rest or hindered movement in normal operation mode. In a forward flow washing operation mode, the carriers become fluidized by reducing the filling degree of the carriers for removing excess sludge.

A reactor for biological purification of water is known from CN 1730410 A. The reactor contains carrier for biofilm growth and these elements have a specific weight of 0.7-0.95 and the degree of filling for the carriers is 50-90% of the effective volume of the reactor.

CN 02104180.6 describes a reactor that is divided into an up-flow zone and a down-flow zone with baffles. The reactor contains carriers for biofilm growth and a membrane filtration device for separation. The carriers can be in forms of particulates, powder or small chunks. The membrane is situated in the up-flow zone with aerators fixed right below the membrane device. Internal water recirculation is created by the aeration in the reactor with the aid of the baffles and current directing plates that are fixed on the walls of the reactor and on the baffles.

U.S. Pat. No. 7,288,197 describes a biological purification system that comprises a moving bed zone and a membrane separation zone. The moving bed zone contains porous carriers made of polymer foam for biofilm growth. The carriers are retained in the moving bed zone by two filtration screens, one on the top and the other one at the bottom of the zone. Effluent water from the moving bed zone is further purified with membrane filtration in the membrane separation zone.

JP 07328624 A describes a method for biological purification of waste water by using a rector with immobilized carrier elements for biofilm and membranes submerged in the reactor and air is introduced via nozzles in the bottom of the reactor.

JP 06285496 A describes a method for biological purification of waste water, where the waste water are introduced into a reactor with submerged membranes and urethane foam carrier elements for biofilm. Air is introduced into the bottom of the reactor in order to create turbulence.

U.S. 2005/026985 A1 describes a method for water treatment where the water is led through a reactor filled with carrier elements and first and second bio membranes.

### DESCRIPTION OF THE INVENTION

The present invention relates to a method for biological purification of municipal wastewater, industrial wastewater, surface water and ground water in a bioreactor where water and substrate come into contact with carrier elements for biofilm growth and effluent water (permeate) comes out by membrane filtration in a submerged membrane system that is placed in the bioreactor where the carrier elements are retained.

The method is characterized in
leading the water into a reactor through one or more inlet pipes or inlet zones;
leading the water and substrate through carrier elements for biofilm growth which have a high protected surface area (>200 m²/m³ carrier elements) and a large pore volume (>60%);
wherein one or more membrane units are submerged in the water in the reactor;
wherein permeate is pulled out of the reactor through the pores of the membranes;
wherein oxygen-containing gas is supplied in the reactor through an aeration system;
wherein during normal operation the water level in the reactor is maintained below one or more outlet pipes or outlet zones that are dedicated for excess sludge removal;
wherein during washing operation strong turbulence is created for removal of excess sludge as the water level in the reactor is temporarily raised to the level where the outlet pipes or outlet zones that are dedicated for excess sludge removal are.

When the water level in the reactor is raised temporarily to the level where the outlet pipes or outlet zones that are dedicated for excess sludge removal are, a mixing mechanism is applied to create strong turbulence in the reactor so that the excess sludge is torn from the elements and the membrane surface and sedimented sludge is suspended and in that inlet water is led into the reactor through inlet pipes or inlet zones and thus brings sludge out of the reactor through one or more outlet pipes or outlet zones, when the excess sludge has been removed, the water level in the reactor is reduced to the level below where the outlet pipes or outlet zones that are dedicated for excess sludge removal are.

Polluted water is preferably continuously supplied into the reactor through one or more inlet pipes or inlet zones.

The carrier elements have preferably a specific weight that is in the area 0.8 to 1.1.

The degree of filling of the carrier elements during normal operation makes preferably up a corresponding 10% to 99%, more preferred 80% to 99% of the reactor liquid volume.

Permeate that has low turbidity is pulled out of the bioreactor with a submerged membrane filtration system that contains membranes that are made of ceramic materials, metallic materials, polymeric materials or combination of inorganic and polymeric materials and has a nominal membrane pore size below 0.5 micron, which allows the permeate to be reused. The membrane elements can be in either the hollow fibre format or the flat sheet format. Oxygen-containing gas bubbles are provided by aeration devices that are placed at the bottom of the bioreactor, preferably right underneath the membrane elements. The gas bubbles serve several purposes, including providing oxygen as the electron acceptor for micro-organism growth, mobilizing carrier elements and other suspended particles in the bioreactor and scouring off deposits on the membrane surface.

A continuous stream of feed water is preferably supplied to the bioreactor. Periodically, excess sludge is removed with means of raising the water level in the bioreactor by either reducing or stopping permeate flow and/or providing turbulence with the help of mixing appliances, which fluidizes the carrier elements in the bioreactor. The excess sludge exits the bioreactor through one or more sieves that allow the excess sludge to pass through but retain the carrier elements in the bioreactor. Once the water level is raised, the carrier elements will become free moving, and frequent contact between the carrier elements and the membranes will have cleaning effects on the membrane surface.

Membranes become fouled over time, indicated by either a rising trans-membrane pressure (TMP) or a descending permeate flow rate (permeate flux). Periodical membrane relaxation (via stopping filtration) and membrane cleaning (via permeate backwashing with or without chemical solutions) will be applied for sustaining membrane permeability. The degree of membrane fouling and the periodical membrane relaxation/cleaning may result in fluctuating water levels in the bioreactor. Preferably, chemically enhanced cleaning of the membranes are carried out during the same periods that the excess sludge is removed from the bioreactor.

Another preferred feature of the method according to present invention is that the carrier elements can provide cleaning of the surface of the membrane(s) during the washing cycle. This will result in less damage to the membrane surfaces and extend the lifetime of the membranes in relation to prior art solutions.

Further preferred features of the method are described in the dependent claims.

### DRAWINGS

The invention will be explained in the following in more details with the help of embodiment examples with reference to the enclosed figures, where:

FIG. 1A shows schematically normal operation of the bioreactor according to the present invention.

FIG. 1B shows schematically sludge coming loose and being washed out at continuous supply of water to the bioreactor.

FIG. 2A shows normal operation of the bioreactor with effluent water partly overflowed through an outlet pipe.

FIG. 2B shows sludge coming loose and being washed out at continuous supply of water to the bioreactor.

### DETAILED DESCRIPTION OF PREFERRED EMBODIMENTS

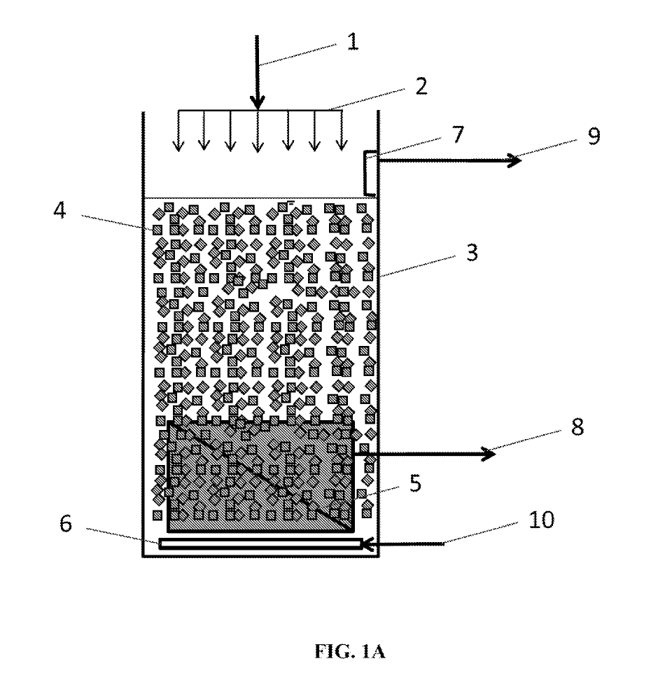

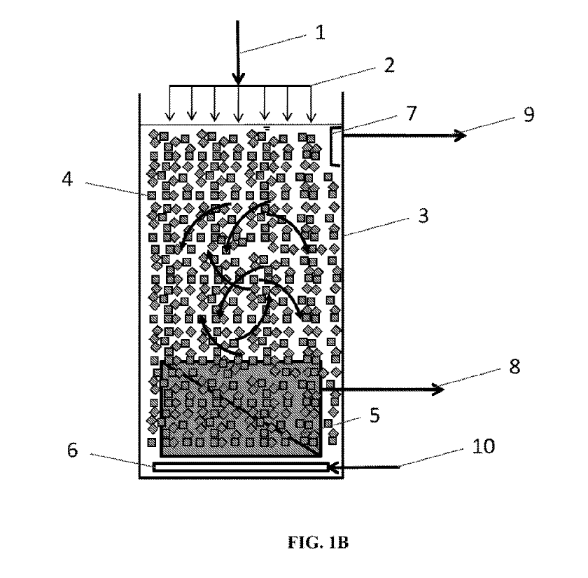

Standard operating procedure for the new biological process without overflow during normal operation is outlined in FIGS. 1A and 1B. The feed water goes through an inlet pipe (1) and a feed water distributor (2) and enters continuously the bioreactor (3) which contains carrier elements (4) for biofilm growth. A submerged membrane unit (5) that is situated in the bioreactor (3) generates permeate (8). An aeration unit (6) introduces oxygen-containing gas (10) into the bioreactor (3). During normal operation (FIG. 1A) the water level in the bioreactor (3) is below the level of the outlet pipe (9) and permeate (8) is the only stream exiting the bioreactor (3). Sludge accumulates in the bioreactor (3).

When one wishes to remove sludge (FIG. 1B), one first reduces or stops the permeate (8) flow rate, which will raise the water level. When the water level rises up to the level of the outlet pipe (9), one ensures very turbulent conditions in the bioreactor so that loose biomass, suspended particles, deposits on the membrane surface and the outer layer of biofilm is torn off and is suspended in the water. The necessary turbulence can be set up by blowing air, and/or with the use of mechanical stirrers or by circulation pumping. The required time for the strong turbulence can be from 1 minute to about half hour, depending on the shape of the bioreactor and the strength of the turbulence. Sufficient feed water must pass through the bioreactor to get the loosened sludge transported out of the bioreactor through pipe (9). The carrier elements are retained in the bioreactor by a sieve (7) that is placed in front of the outlet pipe (9). The necessary amount of water to transport the sludge out of the bioreactor is normally from 0.2 to 3 times of the bioreactor volume, depending on how low the concentration of the suspended solids must be as one again returns to normal operation by increasing the permeate (8) flow rate.

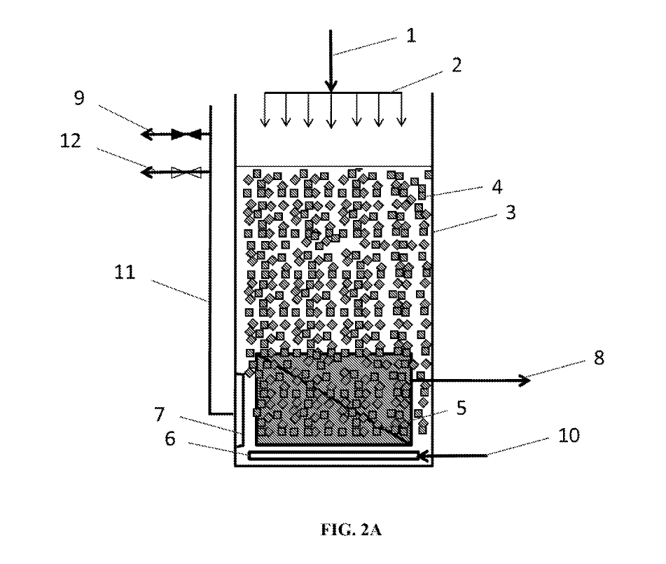

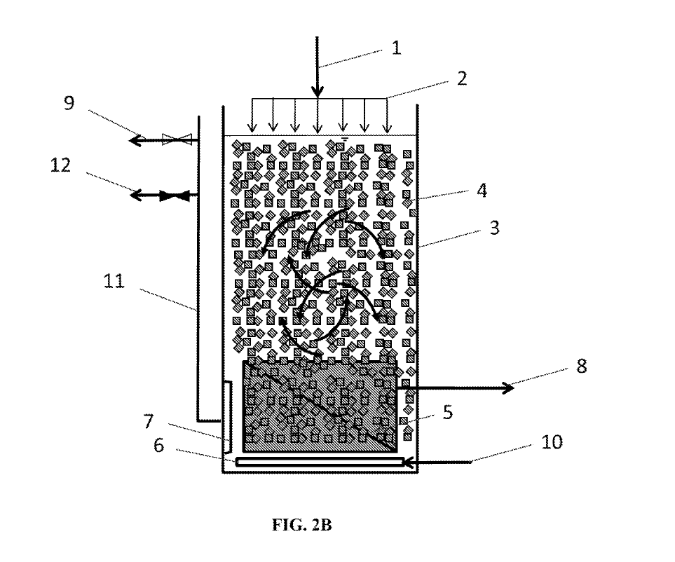

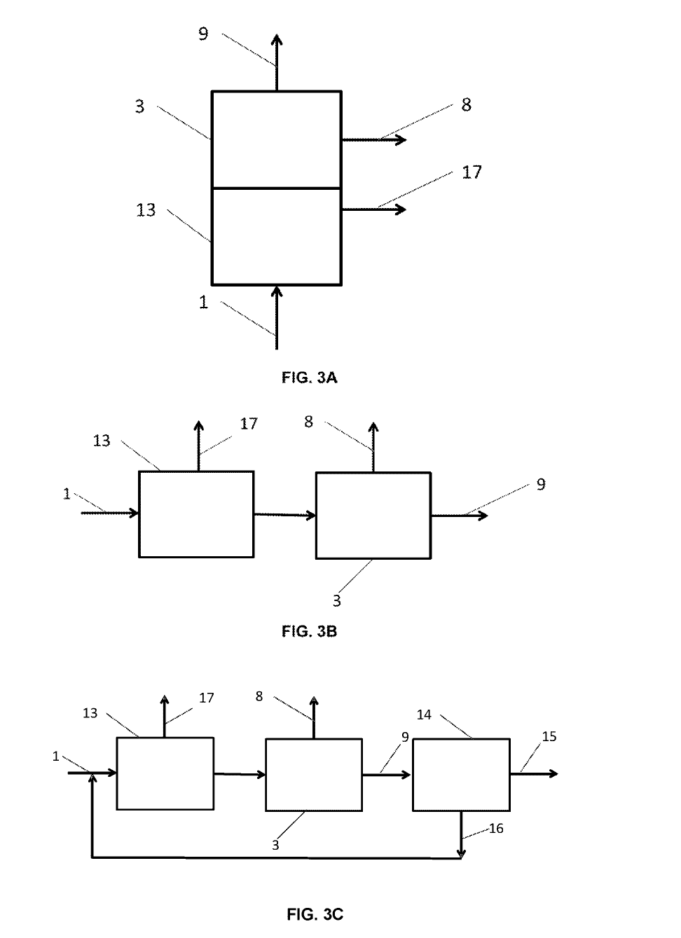

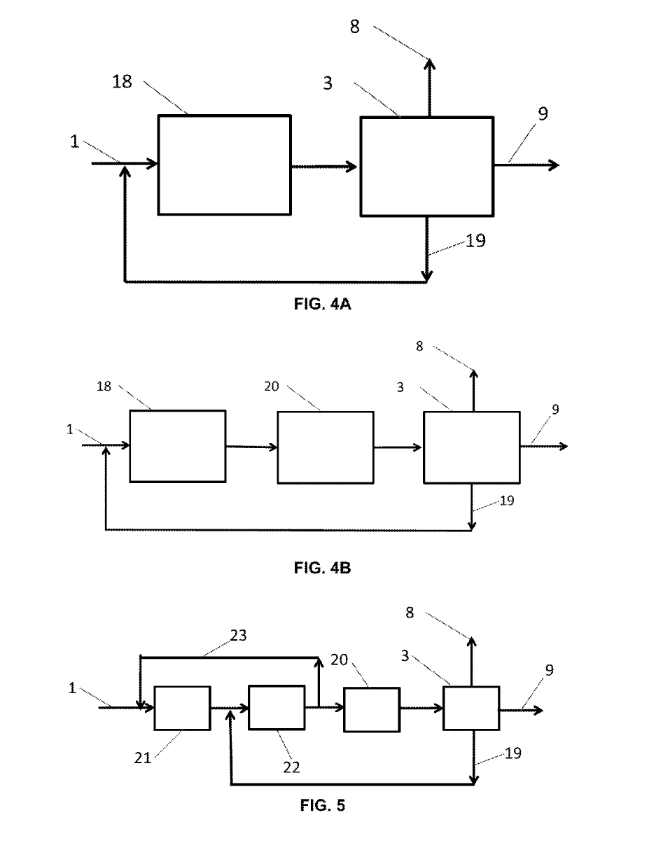

Standard operating procedure for the new biological process with sludge exiting during normal operation is outlined in FIG. 2A and 2B. The feed water goes through an inlet pipe (1) and a feed water distributor (2) and enters continuously the bioreactor (3) which contains carrier elements (4) for biofilm growth. A submerged membrane unit (5) that is situated in the bioreactor (3) generates permeate (8). An aeration unit (6) introduces oxygen-containing gas (10) into the bioreactor (3). During normal operation (FIG. 2A) the water level in the bioreactor (3) can be above the level of a sludge exiting pipe (12) and treated water that contains sludge can exit the bioreactor through a vertical pipe (11) and the sludge exiting pipe (12) via gravity. The sludge can also exit the bioreactor during the normal operation via pumping, which is typically applied when one combines the new bioreactor with one or more other bioreactors in a bioreactor train where recirculation of the sludge and/or water to the other bioreactor(s) is needed. The carrier elements are retained in the bioreactor (3) by a sieve (7) that is placed in front of the vertical pipe (11).

When one wishes to remove excess sludge (FIG. 2B), one first reduces or stops the permeate (8) flow rate and closes the sludge exiting pipe (12), which will raise the water level. When the water level rises up to the level of the outlet pipe (9), one ensures very turbulent conditions in the bioreactor so that loose biomass, suspended particles, deposits on the membrane surface and the outer layer of biofilm is torn off and is suspended in the water. The necessary turbulence can be set up by blowing air, and/or with the use of mechanical stirrers or by circulation pumping. The required time for the strong turbulence can be from 1 minute to about half hour, depending on the shape of the bioreactor and the strength of the turbulence. Sufficient feed water must pass through the bioreactor to get the loosened sludge transported out of the bioreactor through the vertical pipe (11) and the outlet pipe (9). The carrier elements are retained in the bioreactor by the sieve (7) that is placed in front of the vertical pipe (11). The necessary amount of water to transport the sludge out of the bioreactor is normally from 0.2 to 3 times of the bioreactor volume, depending on how low the concentration of the suspended solids must be as one again returns to normal operation by increasing the permeate (8) flow rate and opening the sludge exiting pipe (12).

### EXAMPLES

Application examples with the present invention are described as the following.

The new bioreactor can be a stand-alone aerobic bioreactor for secondary wastewater treatment and effluent water reuse applications.

FIGS. 3A, 3B and 3C show schematically combining the new bioreactor with an anaerobic bioreactor. Firstly, the new bioreactor can be placed right on the top of the anaerobic bioreactor (FIG. 3A). Feed water flows upwards through the anaerobic bioreactor (13) and enters the new bioreactor (3) via orifices between the two bioreactors (13 and 3). The orifices allow water and sludge passing through, but not the carrier elements. Secondly, the new bioreactor can be placed on the side of the anaerobic bioreactor (FIGS. 3B and 3C). Feed water flows through the anaerobic bioreactor and enters the new bioreactor via gravity or pumping. FIG. 3B shows that wash water that comes out of the outlet pipe (9) during the washing operation of the new bioreactor is not recirculated back to the anaerobic bioreactor. FIG. 3C shows that a separation unit, which can be a sedimentation tank, a sludge thickener, a dissolved air flotation unit or a fine mesh sieve, is used to separate sludge (16) from the effluent water (15) in the wash water and the separated sludge (16) is recirculated back to the anaerobic bioreactor (13) for anaerobic digestion. Biogas produced in the anaerobic bioreactor is collected via a biogas venting pipe (17).

FIGS. 4A and 4B show schematically biological nitrogen removal processes integrated with the new bioreactor. In FIG. 4A, a two-stage process, an anoxic fixed film bioreactor (18) is placed in front of the new bioreactor (3). Both removal of organic matters and nitrification occur in the new bioreactor. An internal recirculation stream (19) that is rich with the nitrate ion is recirculated to the anoxic bioreactor. In FIG. 4B, a three-stage process, an anoxic fixed film bioreactor (18) is followed by an aerobic fixed film bioreactor (20) that is followed by the new bioreactor (3). The aerobic bioreactor (20) is designed mainly for removal of organic matters in the feed water and the new bioreactor (3) is mainly for nitrification and membrane filtration. The internal recirculation stream (19) is recirculated to the anoxic bioreactor (18) in the three-stage process.

FIG. 5 shows schematically a combined biological nitrogen and phosphorus removal process integrated with the new bioreactor. The process comprises 4 bioreactors and they are: an anaerobic bioreactor (21), an anoxic bioreactor (22), an aerobic fixed film bioreactor (20) and the new bioreactor (3). Both anaerobic bioreactor (21) and the anoxic bioreactor (22) contain no carrier elements. Organic matters are removed in the first three bioreactors (21, 22 and 20) and partial nitrification occurs in the aerobic bioreactor (20). Further nitrification and membrane filtration occur in the new bioreactor (3). The internal recirculation stream (19) recirculates the nitrate ion and suspended biomass to the anoxic bioreactor (22) for denitrification with the help of hydrolyzed organic matters from the anaerobic bioreactor (21). The second internal recirculation stream (23) recirculates phosphorous accumulating organisms (PAOs) to the anaerobic bioreactor (21). With such a flow arrangement PAOs can take up volatile fatty acids (VFAs) in the feed water, which is converted into energy-rich polymeric compounds inside PAO cells, and when PAOs enters the aerobic bioreactor (20), the stored polymeric compounds can be utilized as energy sources for PAOs to take up phosphorous in the water and store it as poly-phosphate in their cells. Eventually, phosphorus, which has been enriched in PAOs, is removed from the system via the sludge removed in the wash water

Advantages Over the State of the Art Technologies

In relation to the activated sludge+secondary clarification+MF/UF process, the present invention has the following advantages:
The new process eliminates the secondary clarification, which significantly reduces the overall footprint of the process. The sludge bulking problem is not relevant to the new process.
The biomass density in the new bioreactor can be much higher than in the activated sludge processes, which results in higher organic loadings and lower footprints.
Oxygen transfer efficiency in the new bioreactor can be significantly higher than that in the activated sludge processes when high filling degrees of the carrier elements are applied. With approximately stationary carrier elements at high filling degrees, air bubbles have to travel through the highly packed carriers, thereby creating a long retention time and pathway before the air bubbles reach the bioreactor surface.

In relation to the MBR process, the present invention has the following advantages:
In the present invention, the usage of coarse air bubbles for both the biofilm process and the membrane scouring can reduce the high energy consumption which is typically observed for the MBR process.
In the present invention, the collision between the carrier elements and the membrane during washing cycles has cleaning effects on the membrane surface. The precondition is that the carrier elements do not damage the membrane structure and significantly reduce membrane lifetime, which can be realized by proper selection of types of the carrier elements and types of the membranes.
The biomass density in the new bioreactor can be significantly higher than in the MBR process, which results in higher organic loadings and lower footprints.
The majority (>50%) of the biomass in the new bioreactor is in the form of biofilm on the carrier elements, which results in lower suspended solids concentrations than the typical MBR process. Two main advantages are associated with the low suspended solids concentrations: one is that membrane fouling can be alleviated since extremely high suspended solids concentrations reversely affect membrane permeability, and the other one is that the necessity for the high internal recirculation flow (high energy consumption) in the MBR process, which is needed to decrease the sludge concentration difference between the zone that the membranes are located in and the rest of the bioreactor, becomes reduced.
For the new bioreactor, the sludge removal during the forward flow washing operation can be implemented at the same time as conducting the membrane chemically enhanced backwash (CEB) and the membrane clean-in-place (CIP), which are commonly implemented in the MBR process, reducing non permeate producing time.

In relation to the MB-MBR process, the present invention has the following advantages:
In the present invention, the usage of coarse air bubbles for both the biofilm process and the membrane scouring can reduce the high energy consumption which is typically observed for the MB-MBR process.
In the present invention, the collision between the carrier elements and the membrane has cleaning effects on the membrane surface. The precondition is that the carrier elements do not damage the membrane structure and significantly reduce membrane lifetime under the standard operation conditions.
The biomass density in the new bioreactor can be much higher than in the MB- MBR process, which results in higher organic loadings and lower footprints.
For the new bioreactor, the sludge removal during the washing operation can be implemented at the same time as conducting the membrane chemically enhanced backwash (CEB) and the membrane clean-in-place (CIP), which are commonly implemented in the MBR stage of the MB-MBR process, reducing non permeate producing time.

### Description of Reactor Design

The design of the new bioreactor (3) represents no limitation for the invention, but it will typically have a flat bottom and vertical walls. The effective depth of the bioreactor (3) will typically be in the area of 1.5 to 12 meters, normally 3 to 8 meters. The choice of material for manufacture of the bioreactor (3) is of no importance for the process and can be chosen freely.

The inflow of feed water to the bioreactor (3) can be arranged with pipes or channel constructions. The feed water can either enter at the top of the bioreactor so that one has a water level gap (see FIGS. 1A and 1B, and FIGS. 2A and 2B) or one can have a submerged inlet.

The direction of flow of water through the bioreactor can be both horizontal and vertical.

The outlet of excess sludge and recirculation water from the bioreactor can comprise one or more outlet zones, typically with sieves (7) to retain the carrier elements in the bioreactor. The outlets can be placed either close to the top of the bioreactor or close to the bottom of the bioreactor in the case that a vertical pipe (11) is needed to facilitate setting outlet pipe (9 and 12) heights.

There is no limitation for the location of the membrane system in the bioreactor as long as the membrane system is submerged in the water. Preferably, the membrane is placed close and above the aeration system and in a zone where the carrier elements and the other particles in the bioreactor are fluidized.

The aeration system (6) shall be placed at the bottom of the bioreactor, preferably right underneath of the membrane system (5), so that the air is distributed in the largest part of the horizontal extent of the bioreactor and meantime, effectively scour the membrane surface.

1-14. (canceled)

15. A method for biological purification of water, the method comprising:
leading the water into a reactor through one or more inlet pipes or inlet zones;
leading the water and substrate through carrier elements for biofilm growth which have a high protected surface area of >200 m2/m3 carrier elements and a large pore volume of >60%;
wherein one or more membrane units are submerged in the water in the reactor;
wherein permeate is pulled out of the reactor through the pores of the membranes;
wherein oxygen-containing gas is supplied in the reactor through an aeration system;
wherein during normal operation the water level in the reactor is maintained below one or more outlet pipes or outlet zones that are dedicated for excess sludge removal;
wherein during washing operation strong turbulence is created for removal of excess sludge as the water level in the reactor is temporarily raised to the level where the outlet pipes or outlet zones that are dedicated for excess sludge removal are located; and
wherein the increase and reduction of the water level in the reactor are done through reducing or stopping and increasing the permeate flow, respectively.

16. The method of claim 15, wherein when the water level in the reactor is raised temporarily to the level where the outlet pipes or outlet zones that are dedicated for excess sludge removal are, a mixing mechanism is applied to create strong turbulence in the reactor so that the excess sludge is torn from the elements and the membrane surface and sedimented sludge is suspended and in that inlet water is led into the reactor through inlet pipes or inlet zones and thus brings sludge out of the reactor through one or more outlet pipes or outlet zones, when the excess sludge has been removed, the water level in the reactor is reduced to the level below where the outlet pipes or outlet zones that are dedicated for excess sludge removal are.

17. The method of claim 15, wherein polluted water is continuously supplied into the reactor through one or more inlet pipes or inlet zones.

18. The method of claim 15, wherein the carrier elements have a specific weight that is in the area 0.8 to 1.1.

19. The method of claim 15, wherein the degree of filling of the carrier elements during normal operation makes up a corresponding 80% to 99% of the reactor liquid volume, wherein the carrier elements are approximately stationary during normal operation and have no or little scrubbing effects on the membrane surface.

20. The method of claim 15, wherein the membranes are in either the hollow fiber format or in the flat sheet format.

21. The method of claim 15, wherein the membranes are made of ceramic materials, metallic materials, polymeric materials or combination of inorganic and polymeric materials.

22. The method of claim 15, wherein the nominal pore sizes of the membranes are smaller than 0.5 micrometer.

23. The method of claim 15, wherein during the normal operation, a portion of treated water that contains sludge can exit the reactor through one or more outlet pipes or outlet zones either via gravity or via pumping.

24. The method of claim 15, wherein by removal of excess sludge a discontinuous supply of polluted water is supplied to the reactor through one or more inlet pipes or inlet zones, stopping the supply of polluted water after the water level in the reactor has been raised, and providing turbulence with the help of mixing mechanisms to create turbulence in the reactor to fluidize the elements, so that the excess sludge is torn from the elements and the membrane surface and sedimented sludge is suspended, and thereafter lead inlet water into the reactor through one or more inlet pipes or inlet zones, so that sludge can be brought out of the reactor through one or more outlet pipes or outlet zones for sludge.

25. The method according to claim 15, wherein said outlet pipes or outlet zones are provided in the wall of the reactor or by a vertical tube situated external of the reactor.

26. The method according to claim 15, wherein said washing cycle are combined with chemically enhanced cleaning of said membranes (5).

27. The method according to claim 15, wherein the carrier elements provide cleaning of the surface of the membrane(s) during the washing cycle.
